(19) United States
(12) Patent Application Publication
(10) Pub. No.: US 2021/0287576 A1
(43) Pub. Date: Sep. 16, 2021

(54) FOLDABLE DISPLAY APPARATUS

(71) Applicants: BSP CO., LTD., Anyang-si (KR); JOONGWOO M-TECH CO., LTD., Ansan-si (KR)

(72) Inventors: Hong Jin PARK, Anyang-si (KR); Sung Soo PARK, Yongin-si (KR)

(73) Assignees: BSP CO., LTD., Anyang-si (KR); JOONGWOO M-TECH CO., LTD., Ansan-si (KR)

(21) Appl. No.: 17/142,178

(22) Filed: Jan. 5, 2021

(30) Foreign Application Priority Data
Mar. 13, 2020 (KR) 10-2020-0031496

(51) Int. Cl. G09F 9/30; B32B 7/12

(52) U.S. Cl. CPC G09F 9/301; B32B 2457/20; B32B 7/12

(57) ABSTRACT

Disclosed herein is a foldable display apparatus which can reduce occurrence of marks on a folding section thereof, wherein the display apparatus includes a display panel, a mid-frame, and an adhesive layer, the mid-frame is disposed on one surface of the display panel, the adhesive layer is interposed between the display panel and the mid-frame to bond the display panel to the mid-frame and the mid-frame is formed of glass.

### FIELD

The present invention relates to a foldable display apparatus. More particularly, the present invention relates to a foldable display apparatus which can reduce occurrence of marks on a folding section thereof.

### BACKGROUND

In general, display apparatuses widely used in everyday life, such as smartphones and tablet PCs, are small- and medium-sized electronic devices and are highly portable. Recently, as consumers increasingly want to enjoy a large screen experience in a portable display apparatus, flexible or foldable displays are attracting attention as next-generation technology in the field of displays.

A foldable display includes a flexible display panel including pixels to display an image and a support supporting the flexible display panel, such as a mid-frame.

Repeated folding and unfolding of the foldable display causes stress to be concentrated in a folding section of the foldable display. As a result, the flexible display panel undergoes deformation at a portion thereof corresponding to the folding section and thus can fail to properly display an image. Typical mid-frames are generally formed of polyimide (PI) or metal. However, a mid-frame formed of PI has a problem in that the mid-frame has difficulty in returning to the original state thereof as the mid-frame undergoes repeated expansion and restoration due to repeated folding and unfolding of the foldable display. In addition, a mid-frame formed of metal has a problem in that restoring force of the mid-frame is weakened as the mid-frame undergoes repeated expansion and restoration due to repeated folding and unfolding of the foldable display and in that the mid-frame can have marks on a portion thereof corresponding to the folding section when used for a long time.

### SUMMARY

Embodiments of the present invention have been conceived solve such a problem in the art and it is one object of the present invention to provide a foldable display apparatus which can reduce occurrence of marks on a folding section thereof.

The above and other objects of the present invention will become apparent to those skilled in the art from the detailed description of the following embodiments in conjunction with the accompanying drawings.

In accordance with one aspect of the present invention, there is provided a foldable display apparatus including: a display panel; a mid-frame disposed on one surface of the display panel; and an adhesive layer interposed between the display panel and the mid-frame to bond the display panel to the mid-frame, wherein the mid-frame is formed of glass.

In one embodiment, the foldable display apparatus may have a folding section about which the display panel and the mid-frame are folded, and the adhesive layer may be absent in the folding section.

In one embodiment, the foldable display apparatus may have a folding section about which the display panel and the mid-frame are folded, and the mid-frame has a pattern composed of a connection line and a through-portion repeatedly formed at a portion thereof corresponding to the folding section.

According to the embodiments of the present invention, since glass has an elongation close to 0, the ultra-thin mid-frame formed of glass can be under little or no stress when folded. Accordingly, even when the mid-frame undergoes repeated expansion and restoration at a portion corresponding to the folding section due to repeated folding and unfolding of the display apparatus, the mid-frame can hardly undergo wrinkling, as compared with typical mid-frames formed of polyimide (PI) or metal. As a result, the mid-frame can retain good surface quality and can prevent non-uniform light reflection on the surface thereof, thereby improving clarity of displayed images.

In addition, according to the embodiments of the present invention, since the adhesive layer does not have a portion corresponding to the folding section, occurrence of marks on the folding section due to the adhesive layer can be prevented.

Further, according to the embodiments of the present invention, since the mid-frame has a pattern formed at a portion thereof corresponding to the folding section to be stretchable upon folding of the mid-frame, it is possible to more effectively prevent occurrence of marks on a portion of the mid-frame corresponding to the folding section.

It will be understood that advantageous effects of the present invention are not limited to the above and include any advantageous effects conceivable from the features disclosed in the detailed description of the invention or the appended claims.

### DRAWINGS

FIG. 1 is a schematic sectional view of a foldable display apparatus according to a first embodiment of the present invention.

FIG. 2 is a schematic sectional view of a display panel of the foldable display apparatus of FIG. 1.

FIG. 3 is a schematic sectional view of a foldable display apparatus according to a second embodiment of the present invention.

FIG. 4 is a schematic sectional view of a foldable display apparatus according to a third embodiment of the present invention.

FIG. 5 is a plan view of a mid-frame of the foldable display apparatus of FIG. 4.

### DETAILED DESCRIPTION

Reference will now be made in detail to various embodiments, examples of which are illustrated in the accompanying drawings. It should be understood that the present invention may be embodied in different ways and is not limited to the following embodiments. In the drawings, portions irrelevant to the description will be omitted for clarity. Like components will be denoted by like reference numerals throughout the specification.

Throughout the specification, when an element or layer is referred to as being “on,” “connected to,” or “coupled to” another element or layer, it may be directly on, connected to, or coupled to the other element or layer or intervening elements or layers may be present. In addition, unless otherwise stated, the term “includes” should be interpreted as not excluding the presence of other components than those listed herein.

The terminology used herein is for the purpose of describing particular embodiments and is not intended to be limiting. As used herein, the singular forms, “a”, “an”, and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Hereinafter, embodiments of the present invention will be described in detail with reference to the accompanying drawings.

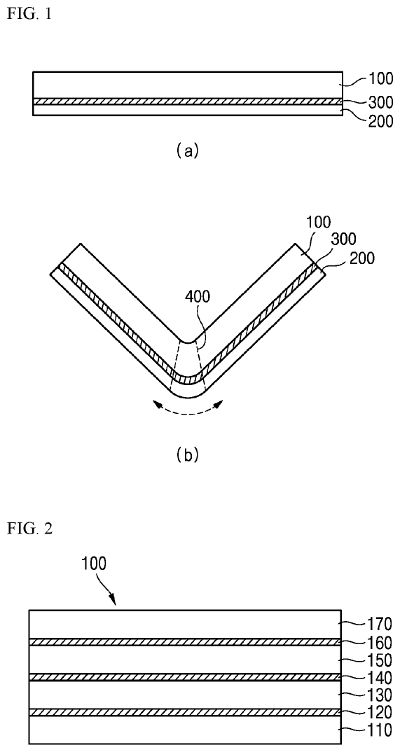

FIG. 1 is a schematic sectional view of a foldable display apparatus according to a first embodiment of the present invention, and FIG. 2 is a schematic sectional view of a display panel of the foldable display apparatus of FIG. 1.

Referring to FIG. 1 and FIG. 2, the foldable display apparatus according to this embodiment may include a display panel 100, a mid-frame 200, and an adhesive layer 300.

The display panel 100 may include any display panel than can function properly when folded, without limitation.

The display panel 100 may include, for example, a light emitting panel 110, a touch panel 130, a polarizing layer 150, and a protective layer 170.

The light emitting panel 110 may be selected from among LEDs, OLEDs, and QLEDs. The touch panel 130 may be bonded to the light emitting panel 110 via a first optically transparent adhesive film 120.

In addition, the polarizing layer 150 may be bonded to the touch panel 130 via a second optically transparent adhesive film 140 and the protective layer 170 may be bonded to the polarizing layer 150 via a third optically transparent adhesive film 160. Each of the first optically transparent adhesive film 120, the second optically transparent adhesive film 140, and the third optically transparent adhesive film 160 may be an OCA film.

The protective layer 170 may be a transparent layer and may be a portion which is exposed outside to be touched by a user when the display apparatus device is installed in an electronic product. The protective layer 170 may be, for example, a polyimide (PI) layer.

The mid-frame 200 may be disposed on one surface of the display panel 100.

The adhesive layer 300 may be interposed between the display panel 100 and the mid-frame 200 to bond the display panel 100 to the mid-frame 200.

In this embodiment, the adhesive layer 300 may be disposed over the entire interface between the display panel 100 and the mid-frame 200. The adhesive layer 300 may be an OCA film.

The display apparatus device may have a folding section 400 about which the display panel 100 and the mid-frame 200 are folded. Upon folding of the display apparatus, the display panel 100, the mid-frame 200, and the adhesive layer 300 may be folded together about respective portions thereof corresponding to the folding section 400.

The mid-frame 200 may keep the display panel 100 flat. The mid-frame 200 may be formed of glass, particularly ultra-thin glass (UTG) having a thickness of 50 μm to 200 μm. Since glass has an elongation close to 0, the ultra-thin mid-frame 200 formed of glass is under little or no stress when folded. Accordingly, even when the mid-frame 200 according to the present invention undergoes repeated expansion and restoration at a portion corresponding to the folding section 400 due to repeated folding and unfolding of the display apparatus, the mid-frame 200 hardly undergoes wrinkling, as compared with typical mid-frames formed of polyimide (PI) or metal. As a result, the mid-frame 200 can retain good surface quality and can prevent non-uniform light reflection on the surface thereof, thereby improving clarity of displayed images.

In addition, since the mid-frame 200 is formed of ultra-thin glass, the height of a center of stress generated in the folding section 400 during folding of the display apparatus can be shifted downwards. In other words, the center of stress generated in the folding section 400 during folding of the display apparatus can be further shifted toward the mid-frame 200. Accordingly, less stress is generated in the protective layer 170 of the display panel 100, whereby durability of the protective layer 170 can be further improved.

Since the protective layer 170 is exposed outside when the display apparatus is installed in an electronic product, it is important to prevent marks, such as wrinkles and cracks, from occurring on the protective layer 170. According to the present invention, since stress generated in the protective layer 170 can be reduced, occurrence of marks, such as wrinkles and cracks, on the surface of the display apparatus can be more effectively prevented.

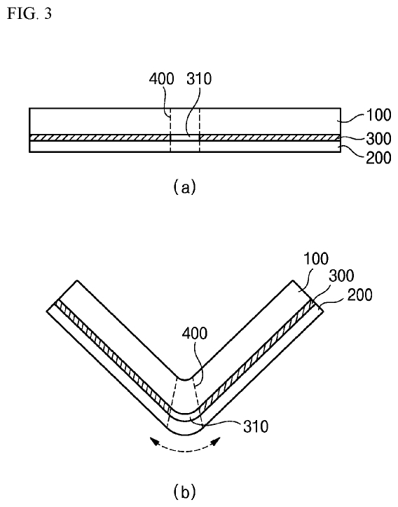

FIG. 3 is a schematic sectional view of a foldable display apparatus according to a second embodiment of the present invention.

Referring to FIG. 3, in the display apparatus according to this embodiment, the adhesive layer 300 may be absent in the folding section 400. That is, the folding section 400 may have an empty space 310, not filled with the adhesive layer 300.

As described above, since glass has an elongation close to 0, the ultra-thin mid-frame 200 formed of glass can be highly resistant to wrinkling upon undergoing repeated folding and unfolding. On the contrary, the adhesive layer 300 can have marks due to stress when folded, causing deterioration in display quality on a screen.

In this embodiment, since the adhesive layer 300 does not have a portion corresponding to the folding section 400, occurrence of marks on the folding section 400 due to the adhesive layer 300 can be prevented.

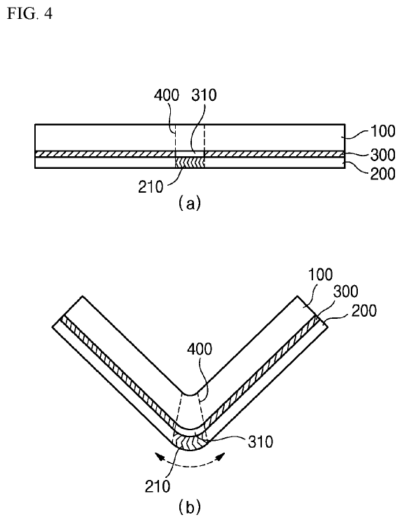

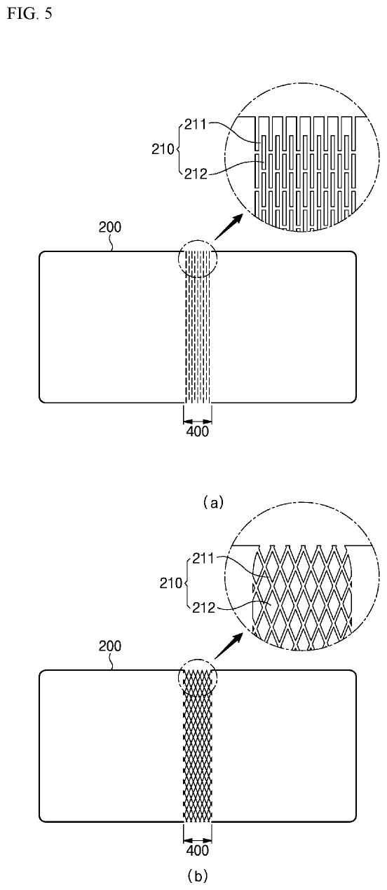

FIG. 4 is a schematic sectional view of a foldable display apparatus according to a third embodiment of the present invention, and FIG. 5 is a plan view of the mid-frame of the foldable display apparatus of FIG. 4.

Referring to FIG. 4 and FIG. 5, in the foldable display apparatus according to this embodiment, the mid-frame 200 may have a pattern 210 at a portion thereof corresponding to the folding section 400.

The pattern 210 may be stretchable when the mid-frame 200 is folded. To this end, the pattern 210 may have a connection line 211 and a through-portion 212. The connection line 211 and the through-portion 212 may be repeatedly formed along the width and length of the mid-frame 200. The through-portion 212 may have a rectangular shape (see FIG. 5(a) or a rhombic shape (see FIG. 5(b)).

Since the pattern 210 is stretched upon folding of the mid-frame 200, it is possible to prevent occurrence of marks on a portion of the mid-frame 200 corresponding to the folding section 400.

Although the folding section 400 is shown as having an empty space 310 not filled with the adhesive layer 300 in this embodiment, it will be understood that the present invention is not limited thereto and the folding section 400 may be filled with the adhesive layer 300 as in the first embodiment.

Although some embodiments have been described herein, it will be understood that various modifications, changes, alterations, and equivalent embodiments can be made by those skilled in the art without departing from the spirit and scope of the invention. Therefore, it will be understood that these embodiments are provided for illustration only and are not to be construed in any way as limiting the present invention. For example, components described as implemented separately may also be implemented in combined form, and vice versa.

The scope of the present invention is indicated by the following claims, and all changes or modifications derived from the meaning and scope of the claims and equivalents thereto should be construed as being included in the scope of the present invention.

### LIST OF REFERENCE NUMERALS

100: Display panel

200: Mid-frame

210: Pattern

300: Adhesive layer

310: Empty space

400: Folding section

What is claimed is:

1. A foldable display apparatus comprising:
a display panel;
a mid-frame disposed on one surface of the display panel; and
an adhesive layer interposed between the display panel and the mid-frame to bond the display panel to the mid-frame,
wherein the mid-frame is formed of glass.

2. The foldable display apparatus according to claim 1, wherein:
the foldable display apparatus has a folding section about which the display panel and the mid-frame are folded; and
the adhesive layer is absent in the folding section.

3. The foldable display apparatus according to claim 1, wherein:
the foldable display apparatus has a folding section about which the display panel and the mid-frame are folded; and
the mid-frame has a pattern composed of a connection line and a through-portion repeatedly formed at a portion thereof corresponding to the folding section.
